(19) United States
(12) Patent Application Publication
(10) Pub. No.: US 2023/0110595 A1
(43) Pub. Date: Apr. 13, 2023

(54) MIXTURE OF PYRETHROIDS AND MILBEMYCINS AND USES THEREOF

(71) Applicant: Valent BioSciences LLC, Libertyville, IL (US)

(72) Inventors: Jason Clark, Elkhorn, WI (US); Banugopan Kesavaraju, High Ridge, MO (US)

(21) Appl. No.: 17/963,270

(22) Filed: Oct. 11, 2022

Related U.S. Application Data
(60) Provisional application No. 63/254,264, filed on Oct. 11, 2021.

(51) Int. Cl. A01N 43/16; A01N 31/08; A01P 7/04

(52) U.S. Cl. CPC A01N 43/16; A01N 31/08; A01P 7/04

(57) ABSTRACT

The present invention is directed to a pesticidal mixture comprising one or more milbemycins and one or more pyrethroids. The present invention is further directed to a method of controlling pests comprising applying a mixture of the present invention to an area in need of pest control.

### FIELD OF THE INVENTION

The present invention is directed to a pesticidal mixture comprising one or more milbemycins and one or more pyrethroids. The present invention is further directed to a method of controlling pests comprising applying a mixture of the present invention to an area in need of pest control.

### BACKGROUND OF THE INVENTION

Arthropods, such as mosquitoes, are often a nuisance to humans and other animals. Arthropods can also be vectors for diseases. Due to the nuisance and public health issues, humans strive to control arthropod populations near their own environments. One way of controlling arthropods is by using pyrethroids.

Pyrethroids are axonic excitotoxins which prevent the closure of the voltage-gated sodium channels in the axonal membranes of arthropods. The toxins work by paralyzing the organism.

While pyrethroids are effective arthropod adulticides, a major problem is that populations of arthropods are developing resistance to them. Pyrethroid resistance, caused either by specific detoxification enzymes or an altered target site mechanism (knockdown resistance (“KDR”)-type mutations in the sodium channels), has been reported on most continents in the majority of medically important mosquito species. If resistance continues to develop and spread at the current rate, it may render such insecticides ineffective in their current form. Such a scenario would have potentially devastating consequences in public health terms because there are as yet no obvious alternatives to many of the pyrethroids.

Resistance is a complex phenomenon arising from exposure to the same or a similar insecticide class over a period of multiple insect generations. Resistance develops due to extinction of susceptible individuals within the population and survival with subsequent reproduction of individuals who are inherently “immune” to the effects of the insecticide. Resistance can be due to multiple factors that include selection of target site mutations, detoxification enzymes and decreased cuticular penetration. Resistance may arise in naïve populations that have been previously identified as insecticide susceptible or those that have been exposed to insecticides of another or similar class or mode of action. Cross resistance can occur and, in addition to physiological resistance, behavioral resistance mechanisms may also be present. The end result of resistance to current control measures is that available insecticides are often inadequate to provide the mortality rates necessary to achieve sufficient levels of arthropod control at environmentally acceptable application rates. Because pyrethroid resistant insects pose a significant human health risk, there is a need in the art for a safe and effective arthropod insecticide.

Milbemycins are macrocyclic lactones that are generated as fermentation products of Streptomyces. Natural milbemycins include milbemycin A3, milbemycin A4, milbemycin D, milbemycin oxime A3, milbemycin oxime A4 and nemadectin. Synthetic milbemycins include moxidectin. Natural milbemycins and synthetic derivatives thereof are known to control helminths and insects.

One type of arthropod that is of major health concern is mosquitoes. The three major genera of mosquitoes which transmit diseases are Anopheles, Culex and Aedes. Therefore, there is a need to control mosquitoes to reduce disease transmission.

Different insecticides can attack at different stage of the insects' development. However, it is the mosquito in the adult stage that transmits viruses and parasites which cause disease. Control of larval stages is a first line of defense for suppression of mosquito populations, but without the capacity to control adult mosquitoes the ability to manage disease can be severely compromised in many settings.

U.S. Pat. No. 9,826,742 is directed to pesticidal mixtures of a pyrethroid and fatty acids at a 1:1:1 ratio of octanoic acid, nonanoic acid and decanoic acid. While this mixture is successful in controlling A. aegypti known to be resistant to pyrethroids alone, there is no guarantee that A. aegypti will not become resistant to such mixtures in the future.

Thus, there is a need in the art for further pesticidal mixtures that are effective on pyrethroid resistant and pyrethroid susceptible arthropods.

### SUMMARY OF THE INVENTION

In one aspect, the present invention is directed to a pesticidal mixture comprising one or more milbemycins and one or more pyrethroids.

In a preferred aspect, the present invention is directed to a pesticidal mixture comprising moxidectin and one or more pyrethroids selected from the group consisting of permethrin and pyrethrum and optionally, C8, 9, 10 fatty acids.

In another aspect, the present invention is directed to a method of controlling a mosquito comprising applying an effective amount of a mixture of the present invention to the mosquito or an area in need of mosquito control.

In another aspect, the present invention is directed to a method of controlling a mosquito comprising applying sequentially or concurrently an effective amount of moxidectin and an effective amount of one or more pyrethroids selected from permethrin and pyrethrum to the mosquito or an area in need of mosquito control.

### DETAILED DESCRIPTION OF THE INVENTION

Applicant discovered that a mixture of one or more milbemycins and one or more pyrethroids is highly effective at controlling pests, especially mosquitoes. Application of the mixtures of the present invention provide a high mortality rate to arthropods including strains that are known to be resistant to pyrethroids or milbemycins alone.

In one embodiment, the present invention is directed to a pesticidal mixture comprising one or more pyrethroids and one or more milbemycins.

In a preferred embodiment, the present invention is directed to a pesticidal mixture comprising moxidectin and one or more pyrethroids selected from the group consisting of permethrin and pyrethrum and optionally, C8, 9, 10 fatty acids.

As used herein the term “milbemycins” includes compounds of formula (I):

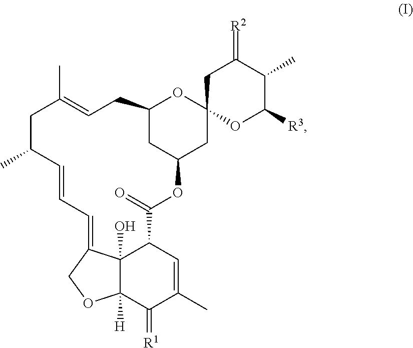

wherein:
R₁ is selected from the group consisting of (—H, (β)—OH) and ═NOH;
R₂ is selected from the group consisting of (—H, —H), ═NOCH₃ and (—H, (α)—OH);
R₃ is selected from the group consisting of —CH₃, —CH₂—CH₃, (Z)—CH(CH₃)₂ and (Z)—C(CH₃)═CH—CH(CH₃)₂.

In a preferred embodiment, the one or more milbemycins are selected from the group consisting of those compounds of Table 1, below.

TABLE 1

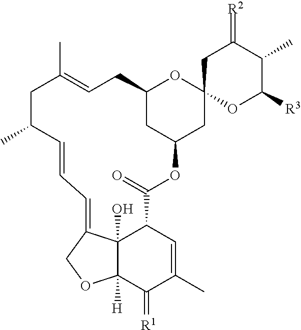

| Compound | R₁ | R₂ | R₃ |
|---|---|---|---|
| Milbemycin A3 | -H, (β)-OH | -H, -H | -CH₃ |
| Milbemycin A4 | -H, (β)-OH | -H, -H | -CH₂-CH₃ |
| Milbemycin D | -H, (β)-OH | -H, -H | (Z)-CH(CH₃)₂ |
| Milbemycin A3 | ═NOH | -H, -H | -CH₃ |
| oxime | | | |
| Milbemycin A4 | ═NOH | -H, -H | -CH₂-CH₃ |
| oxime | | | |
| Nemadectin | -H, (β)-OH | -H, (α)-OH | (Z)-C(CH₃)═CH-CH(CH₃)₂ |
| Moxidectin | -H, (β)-OH | ═NOCH₃ | (Z)-C(CH₃)═CH-CH(CH₃)₂ |

In another preferred embodiment, the one or more milbemycins are selected from the group consisting of milbemycin A3, milbemycin A4, milbemycin D, milbemycin oxime A3, milbemycin oxime A4, nemadectin and moxidectin. In a more preferred embodiment, the milbemycin is moxidectin.

As used herein the term “pyrethroid” includes compounds of formula (II), (III), (IV) and (V):

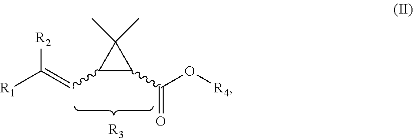

wherein:
R₁ is selected from the group consisting of CH₃, CF₃, Br, Cl and

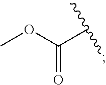

R₂ is selected from the group consisting of H, CH₃, Br and Cl;
R₃ is selected from the group consisting of

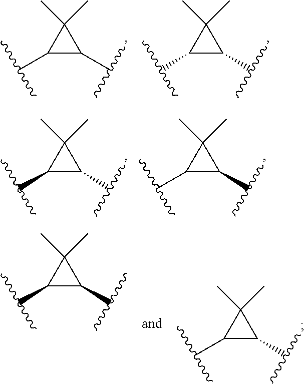

and
R₄ is selected from the group consisting of

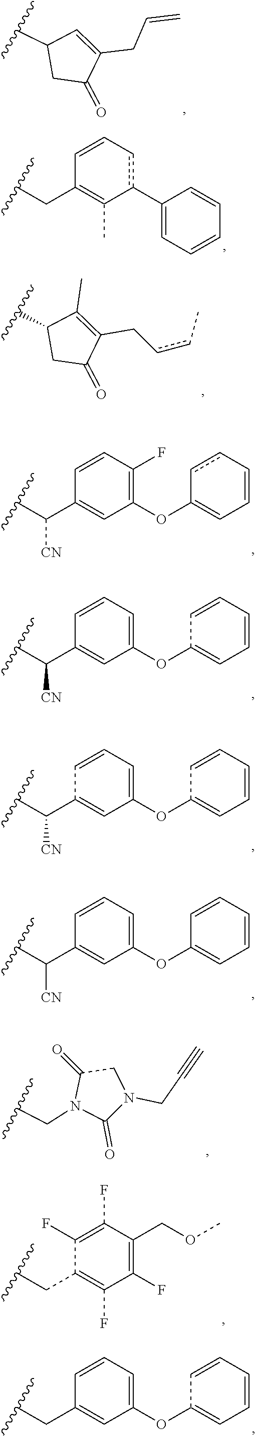

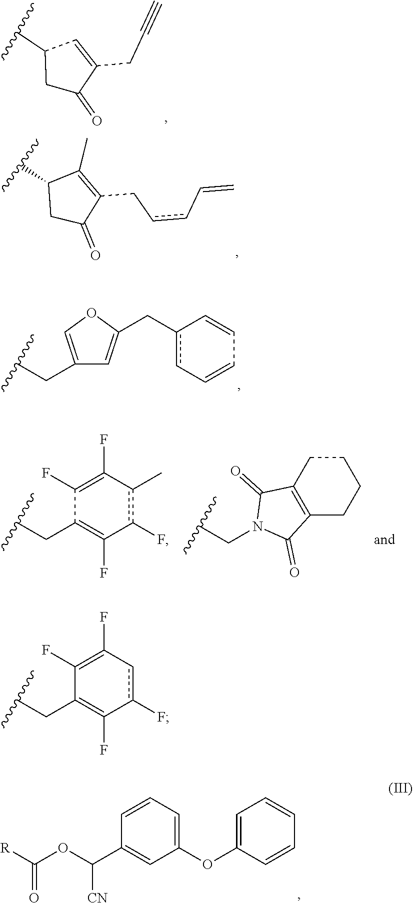

wherein:
R is selected from the group consisting of

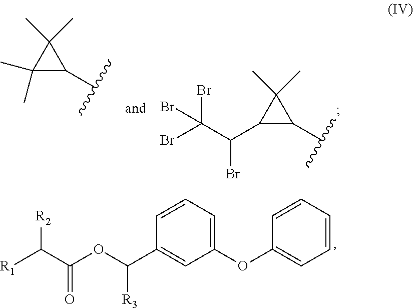

wherein:
R₁ is selected from the group consisting of

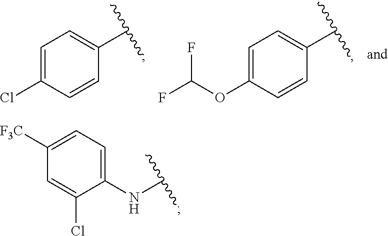

### R₂ is

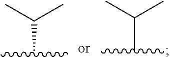

and

### R₃ is

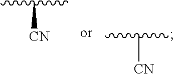

and

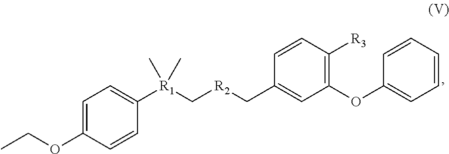

wherein:

### R₁ is C or Si;

R₂ is O or CH₂; and

### R₃ is H or F.

In a preferred embodiment, the one or more pyrethroids are selected from the group consisting of those compounds of Tables 2-5, below.

TABLE 2

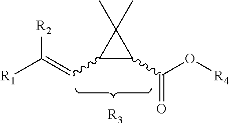

| Compound | R₁ | R₂ | R₃ | R₄ |
|---|---|---|---|---|
| allethrin | -CH₃ | -CH₃ | 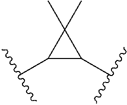 [SMILES: *C1C(*)C1(C)C] | 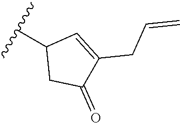 [SMILES: *C1C=C(CC=C)C(=O)C1] |
| bifenthrin | -CF₃ | -Cl | 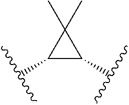 [SMILES: *[C@@H]1[C@H](*)C1(C)C] | 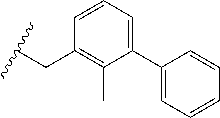 [SMILES: *Cc1cccc(-c2ccccc2)c1C] |
| cinerin I | -CH₃ | -CH₃ | 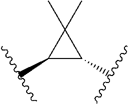 [SMILES: *[C@@H]1[C@@H](*)C1(C)C] | 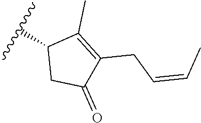 [SMILES: *[C@H]1CC(=O)C(C/C=C\C)=C1C] |
| cinerin II | 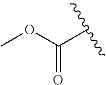 [SMILES: *C(=O)OC] | -CH₃ | 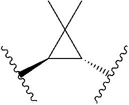 [SMILES: *[C@@H]1[C@@H](*)C1(C)C] | 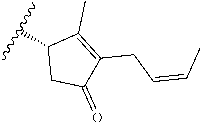 [SMILES: *[C@H]1CC(=O)C(C/C=C\C)=C1C] |
| cyfluthrin | -Cl | -Cl | 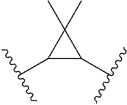 [SMILES: *C1C(*)C1(C)C] | 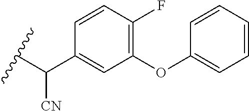 [SMILES: *C(C#N)c1ccc(F)c(Oc2ccccc2)c1] |
| cyfluthrin, β- | -Cl | -Cl | 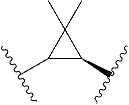 [SMILES: *C1[C@H](*)C1(C)C] | 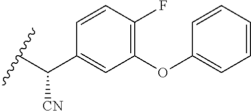 [SMILES: *[C@@H](C#N)c1ccc(F)c(Oc2ccccc2)c1] |
| cyhalothrin, γ | -CF₃ | -Cl | 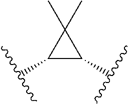 [SMILES: *[C@@H]1[C@H](*)C1(C)C] | 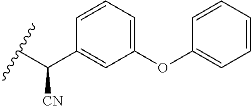 [SMILES: *[C@H](C#N)c1cccc(Oc2ccccc2)c1] |
| cyhalothrin, λ | -CF₃ | -Cl | 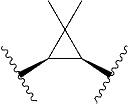 [SMILES: *[C@@H]1[C@H](*)C1(C)C] | 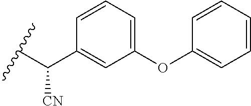 [SMILES: *[C@@H](C#N)c1cccc(Oc2ccccc2)c1] |
| cypermethrin | -Cl | -Cl | 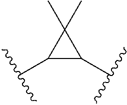 [SMILES: *C1C(*)C1(C)C] | 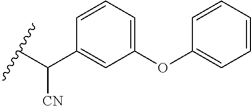 [SMILES: *C(C#N)c1cccc(Oc2ccccc2)c1] |
| cypermethrin, ζ- | -Cl | -Cl | 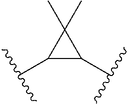 [SMILES: *C1C(*)C1(C)C] | 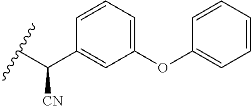 [SMILES: *[C@H](C#N)c1cccc(Oc2ccccc2)c1] |
| cyphenothrin | -CH₃ | -CH₃ | 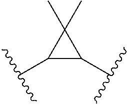 [SMILES: *C1C(*)C1(C)C] | 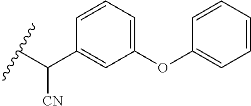 [SMILES: *C(C#N)c1cccc(Oc2ccccc2)c1] |
| cyphenothrin, d-d- T- | -CH₃ | -CH₃ | 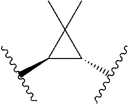 [SMILES: *[C@@H]1[C@@H](*)C1(C)C] | 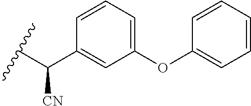 [SMILES: *[C@H](C#N)c1cccc(Oc2ccccc2)c1] |
| deltamethrin | -Br | -Br | 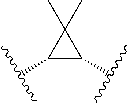 [SMILES: *[C@@H]1[C@H](*)C1(C)C] | 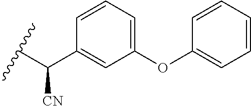 [SMILES: *[C@H](C#N)c1cccc(Oc2ccccc2)c1] |
| imiprothrin | -CH₃ | -CH₃ | 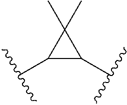 [SMILES: *C1C(*)C1(C)C] | 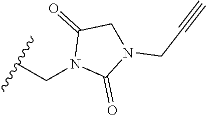 [SMILES: *CN1C(=O)CN(CC#C)C1=O] |
| metofluthrin | -CH₃ | -H | 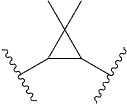 [SMILES: *C1C(*)C1(C)C] | 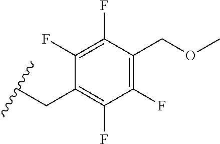 [SMILES: *Cc1c(F)c(F)c(COC)c(F)c1F] |
| permethrin | -Cl | -Cl | 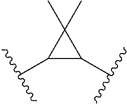 [SMILES: *C1C(*)C1(C)C] | 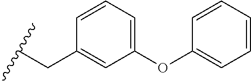 [SMILES: *Cc1cccc(Oc2ccccc2)c1] |
| permethrin, 1-RS- cis- | -Cl | -Cl | 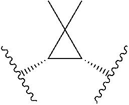 [SMILES: *[C@@H]1[C@H](*)C1(C)C] | 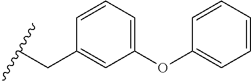 [SMILES: *Cc1cccc(Oc2ccccc2)c1] |
| prallethrin | -CH₃ | -CH₃ | 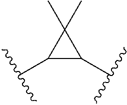 [SMILES: *C1C(*)C1(C)C] | 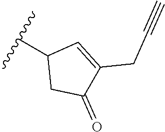 [SMILES: *C1C=C(CC#C)C(=O)C1] |
| pyrethrin I | -CH₃ | -CH₃ | 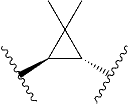 [SMILES: *[C@@H]1[C@@H](*)C1(C)C] | 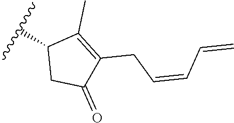 [SMILES: *[C@H]1CC(=O)C(C/C=C\C=C)=C1C] |
| pyrethrin II | 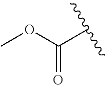 [SMILES: *C(=O)OC] | -CH₃ | 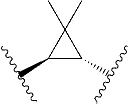 [SMILES: *[C@@H]1[C@@H](*)C1(C)C] | 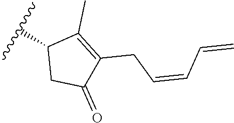 [SMILES: *[C@H]1CC(=O)C(C/C=C\C=C)=C1C] |
| sumithrin | -CH₃ | -CH₃ | 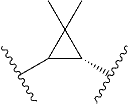 [SMILES: *C1[C@@H](*)C1(C)C] | 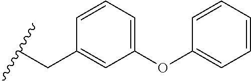 [SMILES: *Cc1cccc(Oc2ccccc2)c1] |
| resmethrin | -CH₃ | -CH₃ | 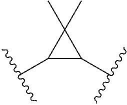 [SMILES: *C1C(*)C1(C)C] | 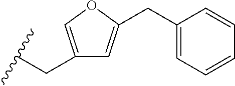 [SMILES: *Cc1coc(Cc2ccccc2)c1] |
| tefluthrin | -CF₃ | -Cl | 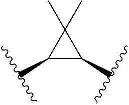 [SMILES: *[C@@H]1[C@H](*)C1(C)C] | 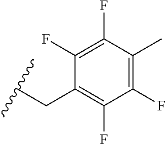 [SMILES: *Cc1c(F)c(F)c(C)c(F)c1F] |
| tetramethrin | -CH₃ | -CH₃ | 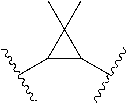 [SMILES: *C1C(*)C1(C)C] | 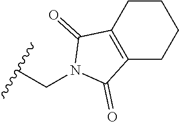 [SMILES: *CN1C(=O)C2=C(CCCC2)C1=O] |
| transfluthrin | -Cl | -Cl | 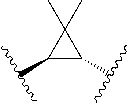 [SMILES: *[C@@H]1[C@@H](*)C1(C)C] | 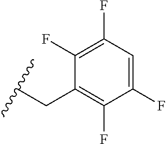 [SMILES: *Cc1c(F)c(F)cc(F)c1F] |

TABLE 3

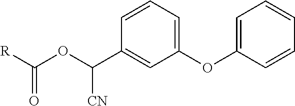

| Compound | R |
|---|---|
| fenpropathrin | 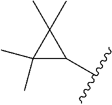 [SMILES: *C1C(C)(C)C1(C)C] |
| tralomethrin | 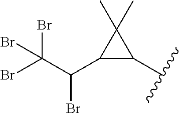 [SMILES: *C1C(C(Br)C(Br)(Br)Br)C1(C)C] |

TABLE 4

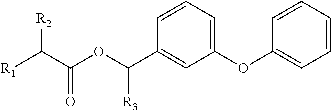

| Compound | R₁ | R₂ | R₃ |
|---|---|---|---|
| esfenvalerate | 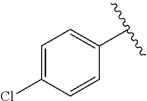 [SMILES: *c1ccc(Cl)cc1] | 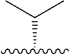 | 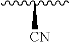 |
| fenvalerate | 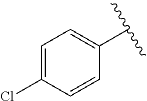 [SMILES: *c1ccc(Cl)cc1] | 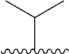 [SMILES: *C(C)C] | 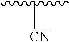 [SMILES: *C#N] |
| flucythrinate | 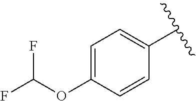 [SMILES: *c1ccc(OC(F)F)cc1] | 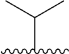 [SMILES: *C(C)C] | 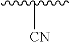 [SMILES: *C#N] |
| fluvalinate, τ- | 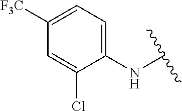 [SMILES: *Nc1ccc(C(F)(F)F)cc1Cl] | 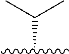 | 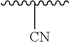 [SMILES: *C#N] |

TABLE 5

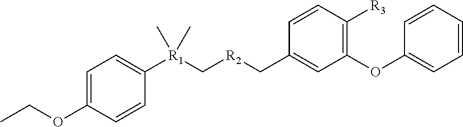

| Compound | R₁ | R₂ | R₃ |
|---|---|---|---|
| etofenprox | C | O | H |
| silafluofen | Si | CH₂ | F |

In a preferred embodiment, the one or more pyrethroids are selected from the group consisting of allethrin, bifenthrin, beta-cyfluthrin, cyfluthrin, cypermethrin, d,d,trans-cyphenothrin, cyphenothrin, deltamethrin, esfenvalerate, etofenprox, fenpropathrin, fenvalerate, flucythrinate, tau-fluvalinate, lambda-cyhalothrin, gamma-cyhalothrin, imiprothrin, metofluthrin, 1RS cis-permethrin, permethrin, prallethrin, pyrethrum, resmethrin, silafluofen, sumithrin (d-phenothrin), tefluthrin, tetramethrin, tralomethrin, transfluthrin and zeta-cypermethrin. In a more preferred embodiment, the one or more pyrethroids is fenpropathrin. In another embodiment, the one or more pyrethroids does not include pyrethrum. In another embodiment, the mixtures of the present invention are free of gamma cyhalothrin or bifenthrin.

As used herein the term “pyrethrum” refers to a composition that includes cinerin including cinerin I and cinerin II and pyrethrin including pyrethrin I and pyrethrin II.

As used herein the term “C8, 9, 10 fatty acids” refers to a mixture of octanoic, nonanoic and decanoic fatty acids. Octanoic, or caprylic acid, is an eight-carbon saturated fatty acid. Nonanoic acid, or pelargonic acid, is a nine-carbon saturated fatty acid. Decanoic acid, or capric acid, is a ten-carbon saturated fatty acid. The C8, 9, 10 fatty acids have an equal amount of each fatty acid by weight percentage (about 33.3% each).

In another preferred embodiment, the ratio of one or more pyrethroids to one or more milbemycins is from about 1000:1 to about 1:1000, preferably from about 100:1 to about 1:100, more preferably from about 50:1 to 1:50, even more preferably from about 20:1 to about 1:20, yet even more preferably from about 10:1 to about 1:10, yet even more preferably from about 5:1 to about 1:5, yet even more preferably from about 5:1 to about 1:1. and yet even more preferably from about 3.3:1 to about 1:1 and yet even more preferably at about 3.3:1, 1.7:1 or 1:1. The ratio of one or more pyrethroids to one or more milbemycins is based on a weight ratio.

In another embodiment, the ratio of one or more pyrethroids to one or more milbemycins is from about 1000:1 to about 1.1:1, preferably from about 100:1 to about 1.1:1, more preferably from about 50:1 to about 1.1:1, even more preferably from about 20:1 to about 1.1:1, yet even more preferably from about 10:1 to about 1.1:1, yet even more preferably from about 5:1 to about 1.1:1, yet even more preferably from about 3.3:1 to about 1.1:1 and yet even more preferably from about 3.3:1 to about 1.7:1 or from about 1.7:1 to about 1.1:1.

In another preferred embodiment, the ratio of one or more pyrethroids to C8, 9, 10 fatty acids is from about 1000:1 to about 1:1000, preferably from about 100:1 to about 1:100, more preferably from about 50:1 to 1:50, even more preferably from about 20:1 to about 1:20, yet even more preferably from about 10:1 to about 1:10, yet even more preferably from about 5:1 to about 1:5, yet even more preferably from about 2:1 to about 1:2 and yet even more preferably from about 1.3:1 to about 1:1.3.

In another embodiment, the ratio of one or more pyrethroids to C8, 9, 10 fatty acids is from about 1000:1 to about 1.1:1, preferably from about 100:1 to about 1.1:1, more preferably from about 50:1 to about 1.1:1, even more preferably from about 20:1 to about 1.1:1, yet even more preferably from about 10:1 to about 1.1:1, yet even more preferably from about 5:1 to about 1.1:1 and yet even more preferably from about 5:1 to about 4:1.

In another embodiment, the ratio of one or more pyrethroids to C8, 9, 10 fatty acids is from about 1:1.1 to about 1:1000, preferably from about 1:1.1 to about 1:100, more preferably from about 1:1.1 to about 1:50, even more preferably from about 1:1.1 to about 1:20, yet even more preferably from about 1:1.1 to about 1:10, yet even more preferably from about 1:1.1 to about 1:5, yet even more preferably from about 1:1.1 to about 1:2 and yet even more preferably from about 1:1.1 to about 1:1.3. In another embodiment the ratio of one or more pyrethroids to C8, 9, 10 fatty acids is or about 1:1. The ratio of one or more pyrethroids to C8, 9, 10 fatty acids is based on a weight ratio.

In another preferred embodiment, the ratio of one or more milbemycins to C8, 9, 10 fatty acids is from about 1000:1 to about 1:1000, preferably from about 100:1 to about 1:100, more preferably from about 50:1 to 1:50, even more preferably from about 20:1 to about 1:20, yet even more preferably from about 10:1 to about 1:10, yet even more preferably from about 5:1 to about 1:5, yet even more preferably from about 2:1 to about 1:2 and yet even more preferably from about 1.3:1 to about 1:1.3.

In another embodiment, the ratio of one or more milbemycins to C8, 9, 10 fatty acids is from about 1000:1 to about 1.1:1, preferably from about 100:1 to about 1.1:1, more preferably from about 50:1 to about 1.1:1, even more preferably from about 20:1 to about 1.1:1, yet even more preferably from about 10:1 to about 1.1:1, yet even more preferably from about 5:1 to about 1.1:1, yet even more preferably from about 2:1 to about 1.1:1 and yet even more preferably from about 1.5:1 to about 1.1:1.

In another embodiment, the ratio of one or more milbemcyins to C8, 9, 10 fatty acids is from about 1:1.1 to about 1:1000, preferably from about 1:1.1 to about 1:100, more preferably from about 1:1.1 to about 1:50, even more preferably from about 1:1.1 to about 1:20, yet even more preferably from about 1:1.1 to about 1:10, yet even more preferably from about 1:1.1 to about 1:5, yet even more preferably from about 1:1.1 to about 1:2 and yet even more preferably from about 1:1.1 to about 1:1.3. In another embodiment the ratio of one or more milbemycins to C8, 9, 10 fatty acids is about 1.5:1. The ratio of one or more milbemycins to C8, 9, 10 fatty acids is based on a weight ratio.

In another preferred embodiment, the ratio of one or more pyrethroids to one or more milbemycins to C8, 9, 10 fatty acids is from about 1000:1:1 to about 1:1:1000 or from about 1000:1:1 to about 1:1000:1 or from about 1:1000:1 to about 1:1:1000 or from about 1000:1000:1 to about 1:1000:1000 or from about 1000:1000:1 to about 1000:1:1000 or from about 1000:1:1000 to about 1:1000:1000, preferably from about 100:1:1 to about 1:1:100 or from about 100:1:1 to about 1:100:1 or from about 1:100:1 to about 1:1:100 or from about 100:100:1 to about 1:100:100 or from about 100:100:1 to about 100:1:100 or from about 100:1:100 to about 1:100:100, more preferably from about 50:1:1 to about 1:1:50 or from about 50:1:1 to about 1:50:1 or from about 1:50:1 to about 1:1:50 or from about 50:50:1 to about 1:50:50 or from about 50:50:1 to about 50:1:50 or from about 50:1:50 to about 1:50:50, even more preferably from about 20:1:1 to about 1:1:20 or from about 20:1:1 to about 1:20:1 or from about 1:20:1 to about 1:1:20 or from about 20:20:1 to about 1:20:20 or from about 20:20:1 to about 20:1:20 or from about 20:1:20 to about 1:20:20, yet even more preferably from about 10:1:1 to about 1:1:10 or from about 10:1:1 to about 1:10:1 or from about 1:10:1 to about 1:1:10 or from about 10:10:1 to about 1:10:10 or from about 10:10:1 to about 10:1:10 or from about 10:1:10 to about 1:10:10, yet even more preferably from about 5:1:1 to about 1:1:5 or from about 5:1:1 to about 1:5:1 or from about 1:5:1 to about 1:1:5 or from about 5:5:1 to about 1:5:5 or from about 5:5:1 to about 5:1:5 or from about 5:1:5 to about 1:5:5 and yet even more preferably from about 2:1:1 to about 1:1:2 or from about 2:1:1 to about 1:2:1 or from about 1:2:1 to about 1:1:2 or from about 2:2:1 to about 1:2:2 or from about 2:2:1 to about 2:1:2 or from about 2:1:2 to about 1:2:2. In a most preferred embodiment the ratio of one or more pyrethroids to one or more milbemycins to C8, 9, 10 fatty acids is from about from about 5:1.5:1 to about 2.5:1.5:1. The ratio of one or more pyrethroids to one or more milbemycins to C8, 9, 10 fatty acids is based on a weight ratio.

In a more preferred embodiment, the present invention is directed to a pesticidal mixture comprising moxidectin and permethrin preferably at a weight ratio of about 1:3.3 moxidectin to permethrin.

In another more preferred embodiment, the present invention is directed to a pesticidal mixture comprising moxidectin and pyrethrum, preferably at a weight ratio of about 1:1.7 moxidectin to pyrethrum.

In another more preferred embodiment, the present invention is directed to a pesticidal mixture comprising moxidectin and pyrethrum, preferably at a weight ratio of about 1:1 moxidectin to pyrethrum.

In another embodiment, the one or more milbemycins of the present invention may exist in a composition at an effective amount. In a preferred embodiment, an effective amount of one or more pyrethroids is a concentration of from about 0.1% to about 50% w/w, preferably from about 0.1% to about 10% w/w, even more preferably from about 0.1% to about 5% w/w, yet even more preferably from about 1% to about 2.5% w/w and yet even more preferably at about 0.5%, 1.5% w/w or 2.5% w/w.

In another embodiment, the one or more pyrethroids of the present invention may exist in a composition at an effective amount. In a preferred embodiment, an effective amount of one or more pyrethroids is a concentration of from about 0.1% to about 50% w/w, preferably from about 0.1% to about 10% w/w, even more preferably from about 0.1% to about 5% w/w, yet even more preferably from about 2.5% to about 5% w/w and yet even more preferably at about 0.5%, 2.5% or 5.0% w/w.

In another embodiment, the C8, 9, 10 fatty acids of the present invention may exist in a composition at an effective amount. In a preferred embodiment, an effective amount of the C8, 9, 10 fatty acids is a concentration of from about 0.1% to about 50% w/w, preferably from about 0.1% to about 10% w/w, even more preferably from about 0.1% to about 10% w/w, yet even more preferably from about 0.1% to about 5% w/w and yet even more preferably at about 1.0% w/w.

In another embodiment, the present invention is directed to a method of controlling a pest comprising applying an effective amount of the mixtures of the present invention to the pest or an area in need of pest control.

In another embodiment, the present invention is directed to a method of controlling a mosquito comprising applying sequentially or concurrently an effective amount of moxidectin and an effective amount of one or more pyrethroids selected from permethrin and pyrethrum to the mosquito or an area in need of mosquito control.

The mixtures of the present invention can be applied by any convenient means. Those skilled in the art are familiar with the modes of application including but not limited to, spraying, brushing, soaking, granule application, pressurized liquids (aerosols), fogging, bait and/or side-dressing. Spraying includes space sprays. Space sprays include aerosols and thermal fog spray. Applying the mixtures of the present invention to the pest include incorporating the mixtures of the present invention into a composition that may be ingested by the pest.

As used herein, “to control” a pest or “controlling” pest(s) refers to killing, incapacitating, repelling, or otherwise decreasing the negative impact of the pest on plants or animals to a level that is desirable to the grower, applicator or user.

As used herein, “an area in need of pest control” refers to any area that the pest is present during any life stage. An area in need of pest control includes, but is not limited to: a) the plants that the pest is living on and/or the surrounding soil; b) an area where plants are grown, harvested, or in gardens, fields, greenhouses; c) indoor areas of human habitation such as residential buildings and commercial buildings including single family dwellings, hotels, daycares, libraries, multi-family residences, jails, hostels, wash rooms, hallways, including hotels, and hospitals, or transportation vehicles; d) outdoor areas around human habitation including areas near mosquito development sites and various indoor surfaces and structures, such as furniture including beds and furnishings including books, etc; and e) fabrics including tents, bed nets, clothing and the like.

Pests that may be controlled by methods of the present invention include, but are not limited to, arthropods. Arthropods include insects, centipedes, millipedes and arachnids.

In one embodiment, the arthropods controlled are resistant to pyrethroids or milbemycins.

In a preferred embodiment, the arthropods are insects. In a more preferred embodiment, the insect is a mosquito. As used herein, “mosquito” refers to insects that belong to the Family Culicidae. Example Subfamilies of mosquitoes include Anophelinae and Culicinae. Example Genera of mosquitoes include Anopheles, Culex, Aedes, Ochlerotatus, Psorophora, Culiseta, Coquillettidia and Mansonia. Example species of mosquitoes include Aedes aegypti, Aedes albopictus, Aedes dorsalis, Ochlerotatus nigromaculis (also known as Aedes nigromaculis), Ochlerotatus vexans (also known as Aedes vexans), Ochlerotatus sollicitans (also known as Aedes sollicitans), Ochlerotatus melanimon (also known as Aedes melanimon), Ochlerotatus taeniorhynchus (also known as Aedes taeniorhynchus), Aedes triseriatus, Aedes, sierrensis, Aedes furcifer, Anopheles gambiae including Mopti and Savannah subspecies, Anopheles quadrimaculatus, Anopheles freeborni, Anopheles darlingi, Anopheles pseudopunctipennis, Anopheles albimanus, Anopheles stephensi, Anopheles funestus, Anopheles nili, Anopheles coluzzii, Anopheles arabiensis, Anopheles melas, Culex quinquefasciatus, Culex pipiens (also known as Culex fatigans), Culex tarsalis, Culex restuans, Culex nigripalpus, Culex salinarius, Culex poicilipes, Culex antennatus, Culex neavei, Culiseta melanura, Psorophora columbiae, Psorophora ciliata, Coquillettidia pertubans, Mansonia africana and Mansonia uniformis.

In a more preferred embodiment, the mosquito is of a genera selected from the group consisting of Culex, Aedes, Anopheles and a combination thereof. In an even more preferred embodiment, the mosquito is of a genera selected from the group consisting of Culex, Aedes and a combination thereof.

In an even more preferred embodiment, the mosquito is selected from the group consisting of Aedes aegypti, Culex quinquefasciatus, Anopheles quadrimaculatus and a combination thereof. In a yet even more preferred embodiment, the mosquito is Aedes aegypti or Culex quinquefasciatus.

In another embodiment, the mixtures of the present invention provide initial arthropod control. In another embodiment, the mixtures of the present invention provide residual arthropod control.

In another embodiment, the one or more milbemycins may be applied at a rate of from about 0.01 to about 100 grams per hectare (“g/HA”), preferably from about 0.1 to about 100 g/HA, more preferably from about 0.1 to about 10 g/HA, even more preferably from about 0.1 to about 5 g/HA, even more preferably from about 0.1 to about 2 g/HA, yet even more preferably from about 0.5 to about 2 g/HA, yet even more preferably from about 0.75 to about 1.5 g/HA and yet even more preferably at about 1 g/HA.

In another embodiment, the one or more pyrethroids may be applied at a rate of from about 0.01 to about 100 grams per hectare (“g/HA”), preferably from about 0.1 to about 100 g/HA, more preferably from about 0.1 to about 10 g/HA, even more preferably from about 0.1 to about 5 g/HA, even more preferably from about 1 to about 5 g/HA, yet even more preferably from about 1 to about 4 g/HA, yet even more preferably from about 2 to about 3 g/HA and yet even more preferably at about 2.68 g/HA.

In another embodiment, the C8, 9, 10 fatty acids may be applied at a rate of from about 0.01 to about 10 grams per hectare (“g/HA”), preferably from about 0.01 to about 1 g/HA, more preferably from about 0.1 to about 1 g/HA, even more preferably from about 0.4 to about 0.9 g/HA, even more preferably from about 0.5 to about 0.8 g/HA, yet even more preferably from about 0.6 to about 0.7 g/HA, yet even more preferably at about 0.67 g/HA.

As used herein, all numerical values relating to amounts, weight percentages and the like are defined as “about” or “approximately” each particular value, namely, plus or minus 10%. For example, the phrase “about 5% w/w” is to be understood as “from 4.5% to 5.5% w/w.” Therefore, amounts within 10% of the claimed values are encompassed by the scope of the claims.

As used herein, “composition” refers to one or more active ingredients in a carrier. The carrier may be a liquid, a semi-solid, a solid or a gas and may contain additional ingredients. For example, a bait is a suitable carrier for the present invention.

The term “effective amount” means the amount of the mixture that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest”, but this can include control of a multiple pests (such as a more than one insect or more than one insect species or more than one mite or more than one mite species).

The disclosed embodiments are simply embodiments of the inventive concepts disclosed herein and should not be considered as limiting unless the claims expressly state otherwise.

The following examples are intended to illustrate the present invention and to teach one of ordinary skill in the art how to use the formulations of the invention. They are not intended to be limiting in any way.

### EXAMPLES

### Example 1-Control of Culex quinquefasciatus by a Mixture of Pyrethrum or Permethrin and Moxidectin

### Method

In this bioassay, a wind tunnel bioassay was performed in the United States of America in May 2021. Culex quinquefasciatus that were known to be resistant and susceptible to permethrin were used in the studies. The following solutions were applied to adult C. quinquefasciatus mosquitoes: 1) 1.5% moxidectin; 2) 5% permethrin; 3) 2.5% pyrethrum; 4) a mixture of 5% permethrin and 1.5% moxidectin; and 5) a mixture of 2.5% pyrethrum and 1.5% moxidectin.

To determine if the mixtures provided unexpected results, the observed combined efficacy (“OCE”) was divided by the expected combined efficacy (“ECE”) wherein the expected ECE is calculated by the Abbott method:

ECE=A+B−(AB/100),

wherein ECE is the expected combined efficacy and in which A and B are the percent control given by the single active ingredients. If the ratio between the OCE of the mixture and the ECE of the mixture is greater than 1, then greater than expected interactions are present in the mixture. (Gisi, Synergistic Interaction of Fungicides in Mixtures, The American Phytopathological Society, 86:11, 1273-1279, 1996). Percent mortality was recorded at 15 minutes (“Min”), 1 hour (“Hr”), 24 hours and 48 hours. Results can be found in Table 6, below.

TABLE 6

| | Permethrin Susceptible | | | | Permethrin Resistant | | | |
|---|---|---|---|---|---|---|---|---|
| | C. quinquefasciatus | | | | C. quinquefasciatus | | | |
| | 15 Min | 1 Hr | 24 Hr | 48 Hr | 15 Min | 1 Hr | 24 Hr | 48 Hr |
| | % Mortality | | | | % Mortality | | | |
| 5% Permethrin | 100 | 100 | 100 | 100 | 35 | 81.25 | 97.5 | 96.25 |
| 2.5% Pyrethrum | 100 | 100 | 98.75 | 97.5 | 41.25 | 75 | 83.75 | 81.25 |
| 1.5% Moxidectin | 53.75 | 67.5 | 92.5 | 92.5 | 15 | 0 | 68.75 | 50 |
| 5% Permethrin | 100 | 80 | 100 | 100 | 73.75 | 2.5 | 86.25 | 72.5 |
| 1.5% Moxidectin | (1.0) | (0.8) | (1.0) | (1.0) | (1.6) | (0.0) | (0.9) | (0.7) |
| 2.5% Pyrethrum | 100 | 100 | 100 | 100 | 85 | 91.25 | 91.25 | 93.75 |
| 1.5% Moxidectin | (1.0) | (1.0) | (1.0) | (1.0) | (1.7) | (1.2) | (1.0) | (1.0) |

### Results

As shown in Table 6, 5% permethrin and 2.5% pyrethrum provided at or near 100% control of C. quinquefasciatus known to be susceptible to permethrin. 1.5% moxidectin provided from 53.75% to 92.5% control.

In regard to C. quinquefasciatus known to be resistant to permethrin, 5% permethrin provided from 35% to 96.25% control, 2.5% pyrethrum provided from 41.25% to 83.75% control and 1.5% moxidectin provided from 0% to 68.75% control. This control is enhanced when moxidectin is mixed with either permethrin or pyrethrum. Specifically, the mixture of 5% permethrin and 1.5% moxidectin or the mixture of 2.5% pyrethrum and 1.5% moxidectin provided an unexpected level of control of C. quinquefasciatus at 15 minutes post application and for pyrethrum and moxidectin at 1 hour post application. Specifically, a mixture of permethrin and moxidectin provided an OCE:ECE ratio of 1.6 at 15 minutes and a mixture of pyrethrum and moxidectin provided and OCE:ECE ratio of 1.7 at 15 minutes and 1.2 at 1 hour.

### Example 2-Control of Culex quinquefasciatus by a Mixture of Pyrethrum and Moxidectin

### Method

In this bioassay, a wind tunnel bioassay was performed in the United States of America in September 2021. Culex quinquefasciatus that were known to be resistant and susceptible to permethrin were used in the studies. The following solutions were applied to adult C. quinquefasciatus mosquitoes: 1) 0.5% moxidectin; 2) 0.5% pyrethrum; and 3) a mixture of 0.5% pyrethrum and 0.5% moxidectin.

Percent mortality was recorded at 15 minutes (“Min”), 1 hour (“Hr”), 24 hours and 48 hours. OCE:ECE ratios were calculated as in Example 1, above. Results can be found in Table 7, below.

TABLE 7

| | Permethrin Susceptible | | | | Permethrin Resistant | | | |
|---|---|---|---|---|---|---|---|---|
| | C. quinquefasciatus | | | | C. quinquefasciatus | | | |
| | 15 Min | 1 Hr | 24 Hr | 48 Hr | 15 Min | 1 Hr | 24 Hr | 48 Hr |
| | % Mortality | | | | % Mortality | | | |
| 0.5% Pyrethrum | 68.75 | 65.00 | 38.75 | 38.75 | 28.75 | 20.00 | 16.25 | 16.25 |
| 0.5% Moxidectin | 1.25 | 26.25 | 95.00 | 95.00 | 0.00 | 0.00 | 11.25 | 8.75 |
| 0.5% Pyrethrum | 76.25 | 86.25 | 88.75 | 88.75 | 0.00 | 22.5 | 43.75 | 43.75 |
| 0.5% Moxidectin | (1.1) | (1.2) | (0.9) | (0.9) | (0.0) | (1.1) | (1.7) | (1.9) |

### Results

As shown in Table 7, 0.5% pyrethrum provided from 38.75% to 68.75% control of C. quinquefasciatus known to be susceptible to permethrin. 0.5% moxidectin provided from 1.25% to 95% control.

In regard to C. quinquefasciatus known to be resistant to permethrin, 0.5% pyrethrum provided from 16.25% to 28.75% control and 0.5% moxidectin provided from 0% to 11.25% control. This control is enhanced when moxidectin is mixed with pyrethrum. Specifically, the mixture 0.5% pyrethrum and 0.5% moxidectin provided an unexpected level of control of permethrin susceptible C. quinquefasciatus at 15 minutes and 1 hour post application and from 1 hour to 48 hours post application for permethrin resistant C. quinquefasciatus. Specifically, a mixture of pyrethrum and moxidectin provided an OCE:ECE ratio of 1.1 at 15 minutes and 1.2 at 1 hour on permethrin susceptible C. quinquefasciatus and a mixture of pyrethrum and moxidectin provided and OCE:ECE ratio of 1.1 at 1 hour, 1.7 at 24 hours and 1.9 at 48 hours on permethrin resistant C. quinquefasciatus.

What is claimed is:

1. A pesticidal mixture comprising moxidectin and one or more pyrethroids selected from the group consisting of permethrin and pyrethrum.

2. The mixture of claim 1, wherein the ratio of the one or more pyrethroids to moxidectin is from about 10:1 to about 1:10.

3. The mixture of claim 1, wherein the ratio of the one or more pyrethroids to moxidectin is from about 10:1 to about 1.1:1.

4. The mixture of claim 1, wherein the ratio of the one or more pyrethroids to moxidectin is from about 3.3:1 to about 1:1.

5. The mixture of claim 1, wherein the ratio of the one or more pyrethroids to moxidectin is from about 3.3:1 to about 1.1:1.

6. The mixture of claim 1, wherein the ratio of the one or more pyrethroids to moxidectin is from about 3.3:1 to about 1.7:1.

7. A method of controlling a mosquito comprising applying sequentially or concurrently an effective amount of a mixture of moxidectin and one or more pyrethroids selected from the group consisting of permethrin and pyrethrum to the mosquito or an area in need of mosquito control.

8. The method of claim 7, wherein the ratio of the one or more pyrethroids to moxidectin is from about 10:1 to about 1:10.

9. The method of claim 7, wherein the ratio of the one or more pyrethroids to moxidectin is from about 10:1 to about 1.1:1.

10. The method of claim 7, wherein the ratio of the one or more pyrethroids to moxidectin is from about 3.3:1 to about 1:1.

11. The method of claim 7, wherein the ratio of the one or more pyrethroids to moxidectin is from about 3.3:1 to about 1.1:1.

12. The method of claim 7, wherein the ratio of the one or more pyrethroids to moxidectin is from about 3.3:1 to about 1.7:1.

13. The method of claim 7, wherein the mosquito is of a genera selected from the group consisting of Culex, Aedes, Anopheles and a combination thereof.

14. The method of claim 7, wherein the mosquito is selected from the group consisting of Aedes aegypti, Culex quinquefasciatus, Anopheles quadrimaculatus and a combination thereof.

15. The method of claim 7, wherein the mosquito is pyrethroid-resistant.

16. The method of claim 7, wherein the area in need of pest control is a bed net, a tent or an item of clothing.

17. The method of claim 7, wherein the control is residual.

18. The method of claim 7, wherein the mixture is applied by a technique selected from spraying, brushing and soaking.
